(19) United States
(12) Patent Application Publication
(10) Pub. No.: US 2005/0262699 A1
(43) Pub. Date: Dec. 1, 2005

(54) Flexible tip pastry server

(76) Inventor: Thomas B. Walker III, Medina, OH (US)

Correspondence Address: MARSHALL, GERSTEIN & BORUN LLP, 233 S. WACKER DRIVE, SUITE 6300, SEARS TOWER, CHICAGO, IL, 60606, US

(21) Appl. No.: 10/855,061

(22) Filed: May 27, 2004

(51) Int. Cl. A21C 5/08; A21C 15/04

(52) U.S. Cl. 30/114

(57) ABSTRACT

A pastry server having a blade with a substantially rigid portion and a flexible tip. A handle extends from the blade for permitting a user to retrieve a slice of pastry from a pastry pan. The flexible tip is operable for flexing and bending to substantially conform to the configured edge shape of the pan to facilitate easy removal of a slice of pastry from the pan.

### FIELD OF THE INVENTION

The present disclosure relates to a pastry server, and more particularly to a pastry server having a flexible tip for bending around the contour of a pan when removing a slice of pastry such as pie or the like.

### BACKGROUND OF THE DISCLOSURE

Pastry cutters and servers are used to cut and serve pastries such as pies and cakes and the like. U.S. Pat. No. 4,114,265 issued to Bailey discloses a cake cutter and server which is formed of an integral piece of material. The server has a first enlarged section hingedly connected to a second triangular shaped section. Formed along the free edge of the second section is a cutting edge. The second section is adapted to be longitudinally pivoted to an approximately 90° angle with respect to the first section. With the server used flat, i.e. non-pivoted, a wedged shaped portion of cake can be cut. Once cut, the wedged shaped cake portion can be readily removed by causing the second section to be pivoted to assume a right angle position to the first section, and then inserting the section under the cake portion and removing such. The second section is also adapted to be pivoted to the right or left to provide convenience of use by a left-handed or right-handed server.

An improvement to prior art pastry servers is contemplated by the present disclosure.

### SUMMARY OF THE DISCLOSURE

The present disclosure provides for a flexible tip pastry server. In one aspect, the flexible tip pastry server includes a blade having a substantially rigid portion and a flexible portion extending from one end of the rigid portion to form and serve as a flexible tip. A handle is connected to the blade for a user to grasp. The handle can be integrally formed with the rigid portion of the blade. The flexible tip can be formed from the same material as the rigid portion of the blade. The flexible tip can include a portion that at least partially includes a thinner cross-section relative to that of the rigid portion. The flexible tip can also be formed from a different material relative to that of the blade. For example, the different material can include a modulus of elasticity that is lower than the rigid portion of the blade.

In another aspect, a pastry cutter and server includes a blade having a substantially rigid portion for supporting a pastry serving. An edge can be formed on the blade for cutting the pastry. A flexible tip can be formed as an extension from the substantially rigid portion of the blade. The handle can be connected to the blade for the user to grasp and remove a slice of pastry.

In yet another aspect of the present disclosure, a method for using a pastry server having a blade with a substantially rigid portion and a flexible tip is provided. The method includes providing a serving pan with a pastry portion disposed therein. The pastry server can be slid between the pastry portion and the pan. The flexible tip of the pastry server can conform to the contoured shape of the pan to facilitate sliding of the server along the initial configured edge and rim surface of the pan until that tip enters the inner reaches of the pastry portion and thus can be generally extended to be in line with the substantially rigid blade. The pastry can then be lifted from the pan and supported by the substantially rigid portion of the blade.

Other applications of the present invention will become apparent to those skilled in the art when the following description of the best mode contemplated for practicing the invention is read in conjunction with the accompanying drawings.

### DETAILED DESCRIPTION OF THE DRAWINGS

FIG. 1 is a perspective view of a pastry server in a first embodiment;

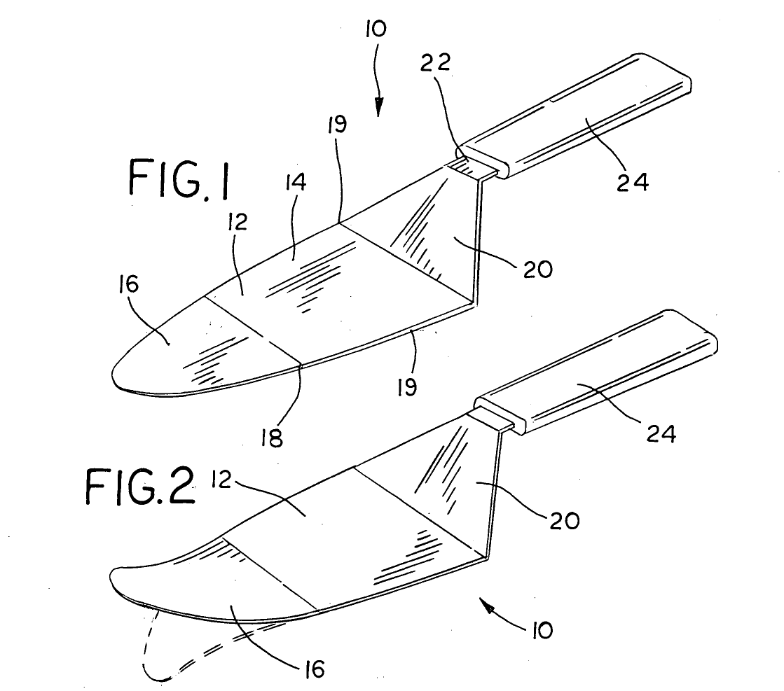

FIG. 2 is a perspective view of the pastry server of FIG. 1 showing a flexible tip blade portion in a bent configuration;

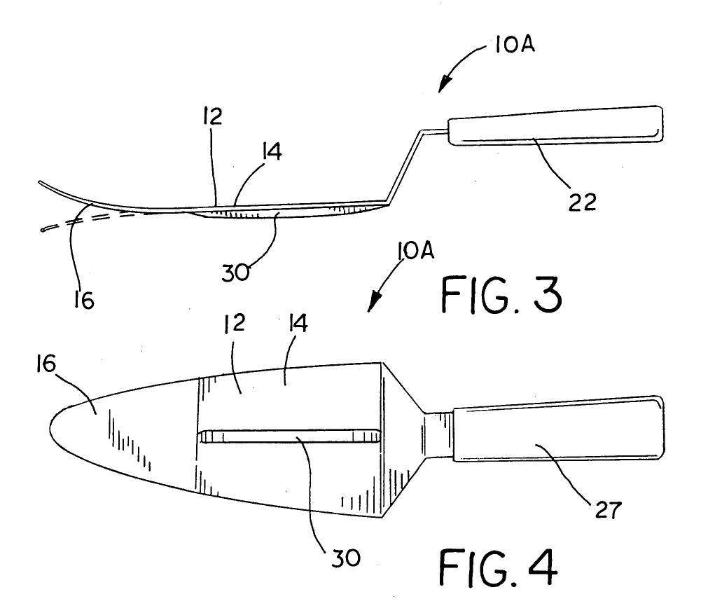

FIG. 3 is a side view of a pastry server in a second embodiment;

FIG. 4 is a bottom view of the pastry server shown in FIG. 3;

FIG. 5 is a side view of a pastry server in a third embodiment;

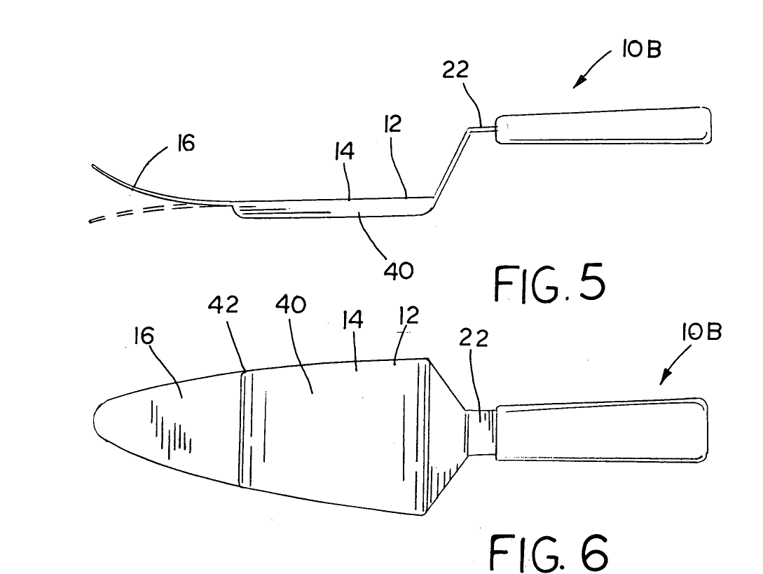

FIG. 6 is a bottom view of the pastry server of FIG. 5;

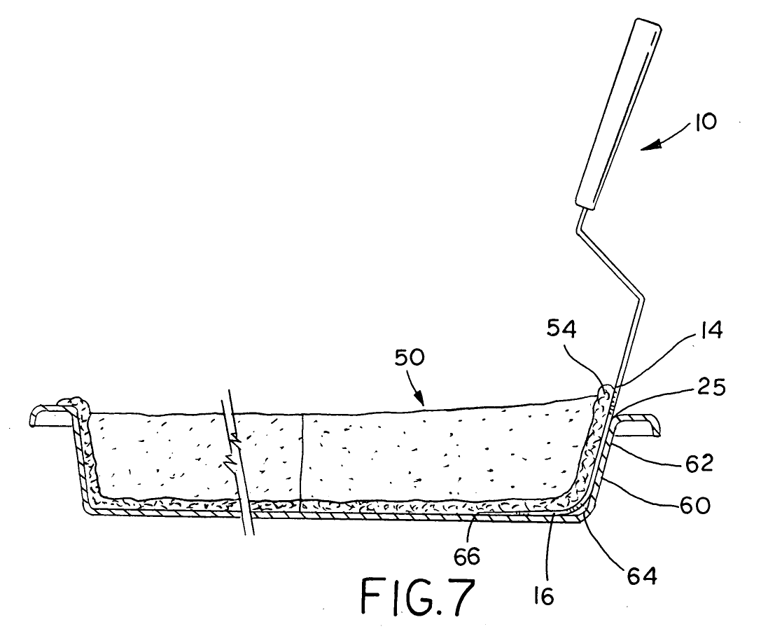

FIG. 7 is a partial cross-sectional view of a pastry located in a pastry pan wherein the pastry server of FIG. 1 is positioned between the pastry and the pan;

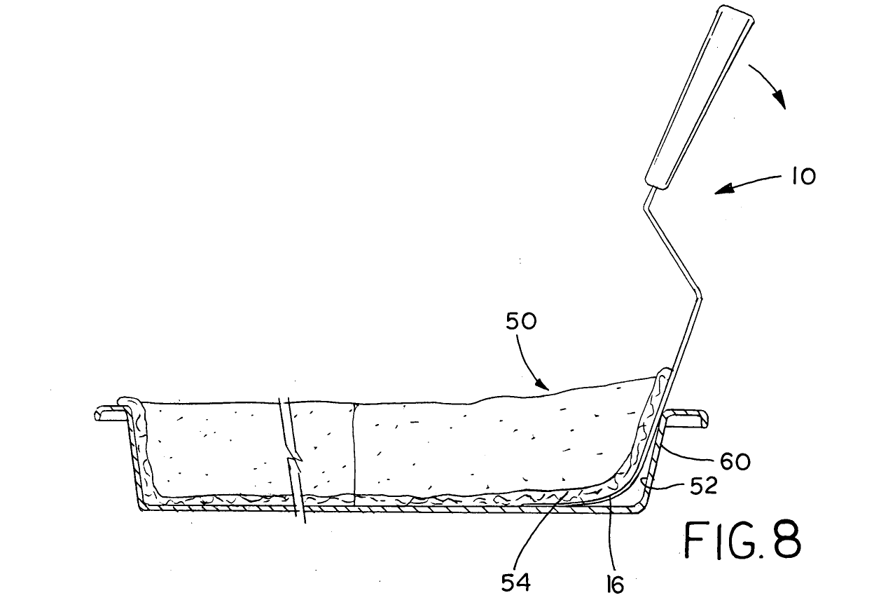

FIG. 8 is a view similar to FIG. 7 but with the pastry server beginning to lift out a slice of pastry;

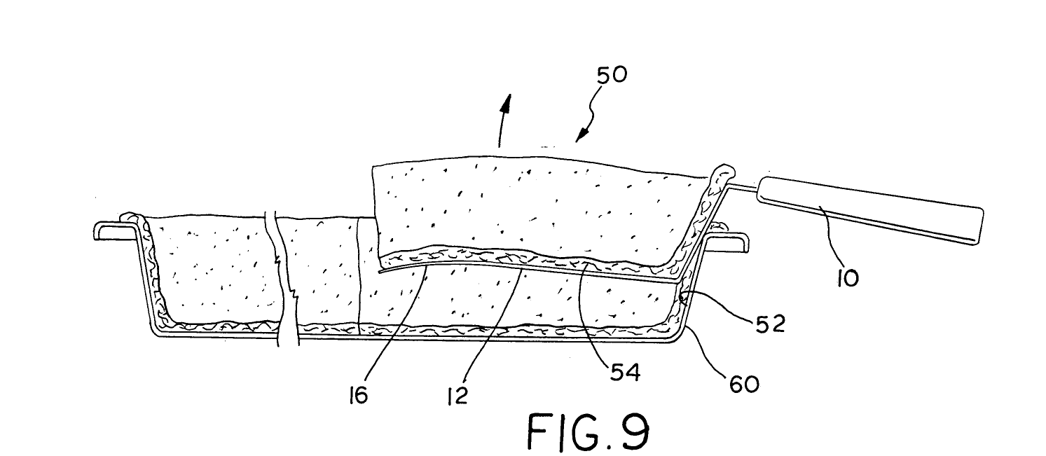

FIG. 9 is a view of FIG. 8 wherein the pastry server has lifted a slice of pastry from the pan.

While the invention has been described in connection with what is presently considered to be the most practical and preferred embodiment, it is to be understood that the invention is not to be limited to the disclosed embodiments, but on the contrary, is intended to cover various modifications and equivalent arrangements included within the spirit and scope of the appended claims, which scope is to be accorded the broadest interpretation so as to encompass all such modifications and equivalent structures as is permitted under law.

### DETAILED DESCRIPTION OF THE DISCLOSURE

Referring to FIG. 1, a pastry server 10 is shown in a first embodiment. The pastry server 10 includes a blade 12 having a substantially rigid portion 14 for supporting the majority of the weight of a slice of pastry. A flexible tip 16 is formed as an extension from the rigid portion 14 of the blade 12. A transversely-aligned joint 18 forms an interface between the flexible tip 16 and the rigid portion 14 of the blade 12. The rigid portion 14 and flexible tip 16 can be formed from any suitable materials, such as thin plate metal, a metal/plastic composite, or a suitable plastic material. If formed of a metal, the joint 18 between tip 16 and portion 14 can be formed by any mechanical attachment such as glue, epoxy, welding, brazing, mechanical fasteners, and the like. If tip 16 and portion 14 are formed of a plastic material, the joint 18 can be formed as a sonic weld, or as a thin cross section joint, such as an injection-molded V-shaped living hinge joint. In one embodiment, the joint 18 can be formed in a thinner cross section than that of either flexible tip 16 or rigid portion 14, so as to assist in the flexibility of tip 16 relative to rigid portion 14.

An edge 19 formed on either side of the pastry server 10 can be used to cut the pastry into slices or portions to facilitate a desired size for the pastry server 10 to then remove from a pastry pan (not shown). An angled extension 20 can be attached to the rigid portion 14 at the opposite end from the flexible tip 16. The angular extension 20 can be formed integrally with the rigid portion 14 of the blade 12. The angular extension 20 can be formed to a desired angle with a metal forming machine or via injection molding, or alternatively the angled extension 20 can be a separate piece that is mechanically attached by epoxy, welding, sonic welding, brazing, threaded fastener, or the like. A handle 22 extends from the angular extension 20 for a user to grasp for manipulating the server 10 when serving the pastry. The handle 22 can include a cover 24 for cushioning the handle 22. The cover 24 can be made of any one of a variety of materials such as plastic, rubber, wire roll, or the like. The rigid portion 14, the angular extension 20, and the handle 22 are designed to be a substantially rigid assemblage such that a piece of pastry can be held without any substantial flexing of these particular components.

Referring now to FIG. 2, the pastry server 10 is shown substantially similar to FIG. 1, however, the flexible tip 16 is shown in an upwardly bent direction (downward in phantom), such as will occur to the tip 16 when removing a pastry slice from a configured-edge pastry pan. The flexible tip 16 can be bent in any direction with a light to moderate force. The flexible tip 16 can be formed from a material having a lower modulus of elasticity relative to that of the rigid portion 14. The flexible tip 16 can be made from rubber, plastic, or other flexible material known to those skilled in the art. In one embodiment the plastic material can be formed from polypropylene.

Referring now to FIGS. 3 and 4, an alternate embodiment of a pastry server 10a is depicted. The substantially rigid portion 14 of the blade 12 can include at least one stiffener such as a longitudinally-aligned rib 30 extending substantially to the flexible tip 16. The rib 30 is operable for providing increased stiffness to the rigid portion 14 so as to prevent the rigid portion 14 from flexing even though the blade cross section is otherwise thin enough to permit bending under typical loads generated by the slice of pastry. The rib 30 can be formed from a different material having a higher modulus of elasticity than the rigid portion 14 of the blade 12, or alternatively may be formed from the same material as the rigid portion 14.

Referring now to FIGS. 5 and 6, yet another alternate embodiment of the pastry server 10b is depicted. In this embodiment, the substantially rigid portion 14 includes a thickened cross-section 40 relative to that of the flexible tip 16. The thickened cross-section 40 extends along the entire width of the blade 12 to provide substantially rigid portion 14 for holding a slice of pastry. The thickened cross-section 40 necks down at the interface 42 with the flexible tip 16. The stiffened portion 14 can be formed of the same material as the flexible tip 16 or alternatively can be made of a different material depending on design criteria.

Referring now to FIGS. 7, 8, and 9, the flexible tip server 10 is shown in operation. A pastry 50 such as pie or the like is positioned in a configured-edge pastry pan 60. The pan includes a configured side wall 62 that extends downward towards a relatively sharp bend 64 which extends into a substantially flat bottom section 66. The pastry server 10 is shown in an initial position wherein the flexible tip 16 flexibly extends around the bend 64 of the pan 60. FIG. 8 shows the pie server 10 as the slice of pastry 50 is being displaced upwardly away from its initial position in the pan 60, shown in FIG. 7. FIG. 9 shows the pastry server 10 holding the slice of pastry 50 in a raised position ready to be transferred to a serving plate or the like. It will be noted that the flexible tip 16 may have a slight downward curvature in this position, depending on the weight of the pastry, but the blade 12 is capable of holding the weight of the slice of pastry 50, irrespective of any bending in the flexible tip 16.

In operation, the pastry server 10 slides between the slice of pastry 50 and the pan 60 along an interface 52. The flexible tip 16 is operable for bending and conforming to the configured contour of the pastry pan 60 so that the edges of the tip 16 will not dig into the pan 60 or into the crust 54 of the pastry slice 50. The flexible tip 16 facilitates the movement of pastry server 10 along the interface 52 between the pastry 50 and the pan 60. The flexible tip 16 can be formed from any suitable material that advantageously bends to conform to the pan as is known to those skilled in the art, but is preferably a plastic material made from polypropylene.

While the preceding text sets forth a detailed description of numerous different embodiments of the invention, it should be understood that the legal scope of the invention is defined by the words of the claims set forth at the end of this patent. The detailed description is to be construed as exemplary only and does not describe every possible embodiment of the invention since describing every possible embodiment would be impractical, if not impossible. Numerous alternative embodiments could be implemented, using either current technology or technology developed after the filing date of this patent, which would still fall within the scope of the claims defining the invention.

1. A flexible tip pastry server comprising:
a blade having a substantially rigid portion and a flexible portion extending from the rigid portion to form the flexible tip; and
a handle connected to the blade for a user to grasp.

2. The flexible tip pastry server of claim 1, wherein the handle is integrally formed with the blade.

3. The flexible tip pastry server of claim 1, wherein the flexible portion is formed from the same material as the rigid portion.

4. The flexible tip pastry server of claim 1, wherein the flexible portion is integrally formed initially with the rigid portion.

5. The flexible tip pastry server of claim 1, wherein the flexible portion at least partially includes a thinner cross section relative to the rigid portion.

6. The flexible tip pastry server of claim 1, wherein the rigid portion includes a stiffener.

7. The flexible tip pastry server of claim 6, wherein the stiffener includes at least one rib.

8. The flexible tip pastry server of claim 6, wherein the stiffener includes a section of material that has a higher modulus of elasticity than that of the flexible portion.

9. The flexible tip pastry server of claim 1, wherein the flexible portion is formed from a different material than the rigid portion.

10. The flexible tip pastry server of claim 1, wherein the flexible portion is formed from a plastic material.

11. The flexible tip pastry server of claim 10, wherein the plastic material is polypropylene.

12. The flexible tip pastry server of claim 1, wherein the flexible portion bends along a joint defined by the interface between the rigid portion and the flexible portion.

13. The flexible tip pastry server of claim 12, wherein the joint is of a thinner cross section than that of the rigid portion.

14. A pastry cutter and server comprising:
a blade having a substantially rigid portion for supporting a pastry serving;
an edge formed on the blade for cutting the pastry;
a flexible tip extending from the rigid portion of the blade; and
a handle connected to the blade for a user to grasp.

15. The pastry cutter and server of claim 14, wherein the handle is integrally formed with the blade.

16. The pastry cutter and server of claim 14, wherein the flexible tip is formed from the same material as the rigid portion of the blade.

17. The pastry cutter and server of claim 14, wherein the flexible tip includes a thinner cross section relative to the rigid blade portion.

18. The pastry cutter and server of claim 14, wherein the blade includes a stiffener.

19. The pastry cutter and server of claim 18, wherein the stiffener includes at least one rib.

20. The pastry cutter and server of claim 18, wherein the stiffener includes material that has a higher modulus of elasticity than that of the flexible tip.

21. The pastry cutter and server of claim 18, wherein the stiffener includes a thicker cross section relative to the cross section of the flexible tip.

22. The pastry cutter and server of claim 14, wherein the flexible tip is formed from a different material than the rigid portion of the blade.

23. The pastry cutter and server of claim 14, wherein the flexible tip is formed from a plastic material.

24. The pastry cutter and server of claim 23, wherein the plastic material is polypropylene.

25. The pastry cutter and server of claim 14, wherein the flexible tip bends proportionately to the weight of the pastry along the tip.

26. The pastry cutter and server of claim 14, wherein a joint separates the flexible tip from the rigid portion.

27. The pastry cutter and server of claim 26, wherein the joint is of a thinner cross section than that of the rigid portion.

28. A method of using a pastry server having a substantially rigid blade with a flexible tip comprising the steps of:
providing a pastry in a pan;
sliding the server between the pastry and the pan, wherein the flexible tip substantially bends to a contoured shape of the pan to facilitate sliding movement of the server; and
lifting the pastry from the pan with the pastry server.

29. The method of claim 28, further comprising the steps of:
initially cutting the pastry with an edge of the server.
